(19) United States
(12) Patent Application Publication
(10) Pub. No.: US 2005/0188274 A1
(43) Pub. Date: Aug. 25, 2005

(54) Watchdog system and method for monitoring functionality of a processor

(75) Inventors: Jude Pragash Vedam, Saidapet (IN); Swaminathan Seetharaman, Chromepet (IN); Pothirajan Kandasamy, Virudhunagar (IN)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Embedded Wireless Labs, Petaling Jaya (MY)

(21) Appl. No.: 10/766,237

(22) Filed: Jan. 29, 2004

(51) Int. Cl. G06F 11/00

(52) U.S. Cl. 714/39

(57) ABSTRACT

The present invention provides watchdog system and method for monitoring the functionality of a processor in communication with the watchdog. In at least one embodiment of the invention, a system of monitoring the functionality of a processor is provided employs a boot up timer, a forbidden timer, an acknowledgement timer, and a cycle period timer. A certain number of acknowledgement signals are expected from the processor at predetermined times in order for the processor to escape reset. For example, a reset signal is asserted to the processor if any one of the following conditions are met: (i) not receiving an acknowledgement signal prior to the expiration of the boot up timer; (ii) receiving an acknowledgement signal prior to the expiration of the acknowledgement timer; (iii) receiving an acknowledgement signal prior to the expiration of the forbidden timer, and (iv) not receiving all of the acknowledgement signals prior to the expiration of the cycle period timer.

### BACKGROUND OF THE INVENTION

1. Field of the Invention

The present invention relates to a watchdog and particularly, to a watchdog system and method for monitoring the functionality of a processor in communication with the watchdog.

2. Description of Related Art

A watchdog is a hardware device used to continuously monitor a processor's functionality, e.g., the software running in the processor, through communications with the processor. Upon determining that the processor is in an unstable or undesirable state, the watchdog sends a reset signal to the processor or some other part of the processor system to reset the processor. When the processor receives the reset signal, it executes a reset routine in a controlled manner. After the reset, the processor initializes itself (“boots up”) and then attempts to operate normally.

U.S. Pat. No. 6,405,328 to Vasanoja, the disclosure of which is hereby incorporated herein by reference in its entirety, describes a watchdog that monitors the time interval between consecutively received acknowledgement signals. The processor is expected to provide acknowledgement signals periodically within a tolerance provided by a tolerance counter. Absence of an acknowledgement signal or the reception of a non-periodic signal results in a reset signal being asserted to the processor, i.e., the watchdog resets the processor when an acknowledgement signal is received either too soon or too late, or is missing altogether. One drawback of this type of watchdog is that it only constrains the periodicity of the received acknowledgement signals, i.e., acknowledgement signals must be received at a specified interval, give or take a degree of tolerance. The sequence or order of the acknowledgement signals is irrelevant. Thus, this type of watchdog can not detect and reset, for example, a bad indefinite-loop process that continuously sends periodic acknowledgement signals. Another drawback of this type of watchdog is that a reset can not be distinguished from, for example, an actual system-reset due to a power failure or a user switching off the system. Moreover, there is no means provided to initiate an alarm notification in the event of frequent system failure.

### SUMMARY OF THE INVENTION

The present invention overcomes these and other deficiencies of the prior art by providing a watchdog system and method that tracks the sequence of acknowledgement signals sent by one or more processors as well as the timing of those signals.

The present invention provides a watchdog that reduces if not eliminates the probability of missing system errors requiring reset by requiring many different acknowledgment signals to be received via N-different IO lines or registers acting as IO lines. By doing such, the sequence of the acknowledgment signals along with their periodicity is monitored.

In at least one embodiment of the invention, a watchdog system for monitoring functionality of a processor is provided comprising: control logic having N number of acknowledgement signal inputs; a first timer, wherein the first timer is started upon boot up of the watchdog system; a second timer; a third timer, wherein the second and third timers are started upon receiving a first acknowledgement signal at one of the N number of acknowledgement signal inputs; and a reset signal generator. The reset signal generator generates a reset signal upon any one of the following conditions being met: (i) not receiving an acknowledgement signal at one of the N number of acknowledgement signal inputs before an expiration of the first timer, (ii) receiving an acknowledgement signal at one of the N number of acknowledgement signal inputs before an expiration of the second timer; and (iii) not receiving an acknowledgement signal at all of the N number of acknowledgement signal inputs before an expiration of the third timer. An interface is provided to couple the processor to the watchdog system.

In at least one embodiment of the invention, a method of monitoring functionality of a processor is provided comprising the steps of: starting a first timer; starting a second timer, receiving at least one acknowledgement signal from a processor or software module; upon the reception of every one of at least one acknowledgement signal, restarting the first timer; and resetting the processor if any one of the following conditions are met: (i) receiving any one of the at least one acknowledgement signal prior to an expiration of the first timer and (ii) not receiving all of the at least one acknowledgement signal prior to an expiration of the second timer. The first and second timers are started simultaneously upon receiving a signal indicating that the processor is properly initialized.

In at least one embodiment the invention, a method for resetting a processor coupled to a watchdog comprises the steps of: monitoring a processor using a watchdog coupled to the processor, resetting the processor using the watchdog, and storing state information of the processor immediately prior to resetting the processor, wherein the state information indicates a state the processor was in prior to reset.

In at least one embodiment of the invention, a watchdog system for monitoring functionality of a processor is provided comprising: control logic having N number of acknowledgement signal inputs; a boot up timer, wherein the boot up timer is started at the start of a boot up of a processor; a forbidden timer, wherein the forbidden timer is started upon start of every operational cycle after completion of a successful boot up of the processor, an acknowledgement timer, wherein the acknowledgement timer is started upon receiving an acknowledgement signal at one of the N number of acknowledgement signal inputs; a cycle period timer, wherein the cycle period timer is started upon start of every operational cycle after completion of a successful boot up of the processor; and a reset signal generator. The reset signal generator generates a reset signal to send to the processor upon any one of the following conditions being met: (i) not receiving an acknowledgement signal at a first one of the N number of acknowledgement signal inputs before an expiration of the boot up timer, (ii) receiving an acknowledgement signal at any one of the N number of acknowledgement signal inputs before an expiration of the acknowledgement timer; (iii) receiving an acknowledgement signal at any one of the N number of acknowledgement signal inputs before an expiration of the forbidden timer and (iv) not receiving an acknowledgement signal at all of the N number of acknowledgement signal inputs before an expiration of the cycle period timer.

In at least one embodiment of the invention, a method of monitoring the functionality of a processor is provided comprising the steps of: starting a boot up timer, starting a forbidden timer; starting a cycle period timer; receiving at least one acknowledgement signal; upon the reception of one of at least one acknowledgement signal, starting an acknowledgement timer; and resetting the processor if any one of the following conditions are met: (i) not receiving any one of the at least one acknowledgement signal prior to an expiration of the boot up timer; (ii) receiving any one of the at least one acknowledgement signal prior to an expiration of the acknowledgement timer; (iii) receiving any one of the at least one acknowledgement signal prior to an expiration of the forbidden timer, and (iv) not receiving all of the at least one acknowledgement signal prior to an expiration of the cycle period timer.

In at least one embodiment of the invention, the watchdog system provides a nonmaskable interrupt (NMI) prior to a reset signal being asserted. A register can be set if the NMI/reset is asserted by itself, thereby providing a means for analyzing the cause of the reset (crash) and the particular module or task that caused the crash. A register is able to distinguish the NMI arising from other sources from the watchdog asserted NMI.

One advantage of the present invention is that it provides a more generic and robust watchdog in view of the prior art.

Another advantage of the present invention is that a number of different Input/Output (IO) lines or registers can be employed, thereby preventing an indefinite loop causing repeated acknowledgement signals from escaping a reset, as the sequence of received acknowledgement signals is just as important as the periodicity or timing of those acknowledgement signals.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the invention, the objects and advantages thereof, reference is now made to the following descriptions taken in connection with the accompanying drawings in which:

FIG. 1 illustrates a watchdog system (or “state machine”) according to at least one preferred embodiment of the invention.

FIG. 2 illustrates an overall state diagram of the watchdog system according to at least one embodiment of the invention; and

FIG. 3 illustrates a watchdog policy according to at least one embodiment of the invention.

### DETAILED DESCRIPTION OF PREFERRED EMBODIMENTS

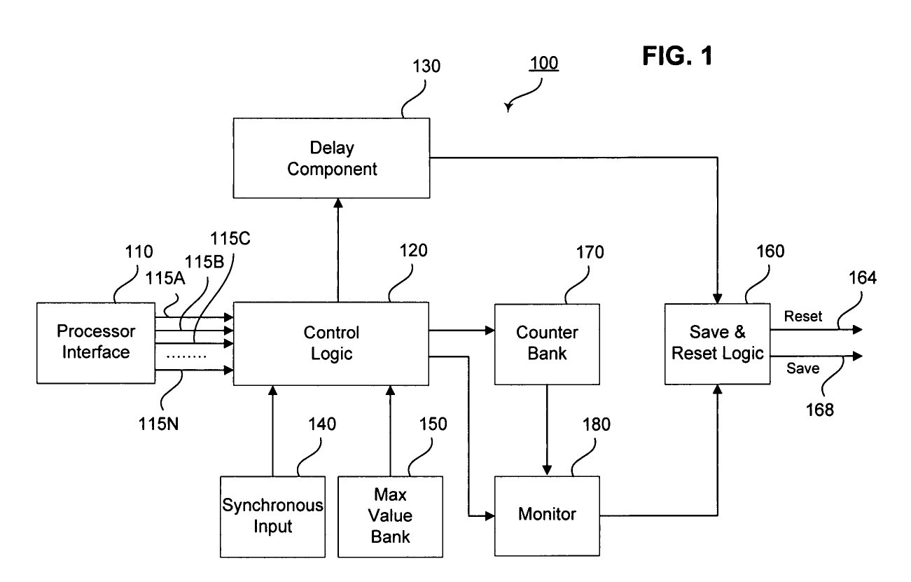

The preferred embodiments of the invention are now described with reference to FIGS. 1-3. These preferred embodiments are discussed in the context of a computer processor system including one or more processors to be monitored by a watchdog. The term processor denotes any logic, circuitry, hardware, code, software, and the like or any combination thereof, which can execute one or more instructions or accomplish tasks, the implementation of which is apparent to one of ordinary skill in the art. Nonetheless, the invention is applicable to any type of machine or process that requires state monitoring and/or a certain degree of synchronicity or timing accuracy.

Typically, the embedded software running in a processor has the following sequence of control flow. On power up, a reset signal is removed off the processor once the crystal and power is stabilized. The processor then starts executing code from a known address referred to as a Reset Vector, which preferably is in Read Only Memory (ROM). Typically ROMs are not fast enough for running actual code from it. Accordingly, the useful code has to be run from Random Access Memory (RAM), e.g., Synchronous Dynamic RAM (SDRAM), which is faster than ROM. Thus, the Reset Vector has a piece of code, which moves the actual code from ROM to RAM and starts executing the code from RAM. This piece of Code is called a Boot Loader and the process is known as ‘boot loading’. The software normally starts running after initialization of the peripherals and other software modules, e.g., variables, interrupt registers, and states as used by rest of the code. Once initialization is over, the processor system starts functioning as per its requirements. The requirements are met using individual software modules called tasks. Depending on the complexity of the processor system, the processor system may have one or many tasks. A task can be considered as an individual program by itself, which can process data, handle the user input and/or output, and interact with other tasks. The tasks are run (started/stopped/blocked) by a kernel, which is a part of the operating system. The watchdog system according to at least one embodiment of the present invention can be implemented in hardware to monitor every stage of the software's performance and find an instability and/or crash at the earliest point of time, thereby restoring software operations and/or resetting the processor system.

FIG. 1 illustrates a watchdog system (or “state machine”) 100 according to at least one embodiment of the invention. Particularly, the watchdog system 100 comprises a processor interface 110, control logic 120, a delay component 130, a synchronous input 140, a max value bank 150, save & reset logic 160, a counter bank 170, and a monitor 180. The processor interface 110 couples the control logic 120 to one or more processors (not shown) (referred to as “the processor” herein) being watched, i.e., monitored. For example, the processor interface 100 is connected to the processor's bus, the implementation of which is apparent to one of ordinary skill in the art. In a preferred embodiment of the invention, the processor interface 110 provides to the control logic 120 a number “N” of unique Input/Output (IO) lines 115A-N, each of which is associated with a corresponding N^{th} acknowledgement signal to be generated by the processor. As will be further described in greater detail, the processor toggles each of the IO lines 115A-N in a specific manner to avoid reset.

In an alternative embodiment of the invention, N registers (not shown) or the like are implemented in place of the IO lines 115A-N in order to either allow a processor without IO lines to be monitored or to monitor a processor employing IO lines, but freeing any number of those IO lines for some other purpose. In this type of implementation, an acknowledgement signal corresponds to the writing of a data pattern to a particular register. Preferably, a unique data pattern is written to each register. Although each register can be identified by a unique address, it is preferable that a unique data pattern is also written to each register. For example, the processor executes a write operation so that a unique data pattern (e.g., 0xAA) to a particular register location (e.g., 0xFF880000). This avoids any erroneous pointer operation in the processor's software that could provide a false acknowledgement signal. Requiring unique data to be written to a number of registers with different addresses reduces the probability of the watchdog system 100 being duped by a false acknowledgement signal. This type of configuration can be implemented by a Field Programmable Gate Array (FPGA).

The control logic 120 is coupled to the counter bank 170, which comprises three counters/timers (not shown) that enable the watchdog system 100 to monitor the functionality of the processor. These three counters are referred to as a cycle period counter, a forbidden period counter, and an acknowledgement period counter, the implementation of which is described in greater detail in the following paragraphs. The control logic 120 actuates these counters at certain times to count an appropriate number of synchronous input events provided by the synchronous input 140. The synchronous input 140 is a periodic event input such as an oscillator or any other type of timing generator or interface that provides an accurate periodic signal. For example, a frame synchronization signal from an E1 pulse-code modulation (PCM) digital line can be employed, the implementation of which is apparent to one of ordinary skill in the art, to drive the counters.

Coupled to the control logic 120 is a delay component 130, which is a timer that provides a specified delay (“boot up period”) for the processor during start up. This boot up period specifies an amount of time ample enough for the processor to initialize and send an acknowledgment signal. Accordingly in at least one embodiment of the invention, an acknowledgement signal is expected before the expiration of the boot up period. Should the control logic 120 receive an acknowledgement signal via, for example, IO line 115A, after the expiration of the boot up period, but not during, thus indicating that processor failed to properly initialize, the delay component 130 triggers a reset of the processor. Whenever the processor is reset, the delay component 130 is immediately restarted to time another boot up period.

The max value bank 150 comprises memory that stores predetermined threshold values for the boot up period timer and the cycle period, forbidden period, and acknowledgement period counters. These values can be configured depending on the particular operational characteristics of the processor being monitored. Preferably, these values are read only by the control logic 120 and are not erasable or re-programmable by the software in the processor as the processor could otherwise modify these values to escape reset.

The save & reset logic 160 is the component that actuates a reset signal to reset the processor. Particularly, the save & reset logic 160 provides a reset signal 164 to the processor when appropriate. In an optional embodiment of the invention, the save & reset logic 160 further asserts to the processor a save signal 168, which can be implemented as a nonmaskable interrupt (NMI). In such a configuration, the save signal 168 precedes the reset signal 164 and stores information to identify data surrounding the cause for reset and any other essential data that might be useful for debugging. This is particularly useful in a multitasking/multiprocessor environment where an IO line is controlled by an individual software module/processor. For example, a typical NMI handler, i.e., Interrupt Service Routine (ISR), can store vital task/hardware states and also identify and store the event that triggered this interrupt, e.g., the NMI might have risen due to many reasons including, but not limited to a power failure or a user resetting the processor system. Moreover, the ISR can store the information identifying the particular IO line misbehaved, i.e., wasn't toggled. This can provide necessary debug information to help identify which IO line caused the reset. By saving information reflecting whether the IO lines 115A-N were toggled or not (or the data last written to N registers) on the cycle immediately preceding reset, the particular module or component of the processor that failed and/or the particular parameter can be identified. This information not only enables the cause of the reset to be identified, but also provides invaluable data for restoring the processor to its last proper operational state.

The monitor 180 supervises the periodicity and the order of the acknowledgement pulses received by the control logic 120 according to a stored supervision policy, which will be described in detail in the following paragraphs. Preferably, any violation of this policy triggers the save & reset logic 160 to reset the processor. For example, the monitor 180 instructs the save & reset logic 160 to reset the process if it finds that not all of the N number of acknowledgement signals are received before the expiration of the cycle period or that any one of the N number of acknowledgement signals is received during the forbidden or acknowledgement periods, or that the specific order of the received acknowledgment signals is improper.

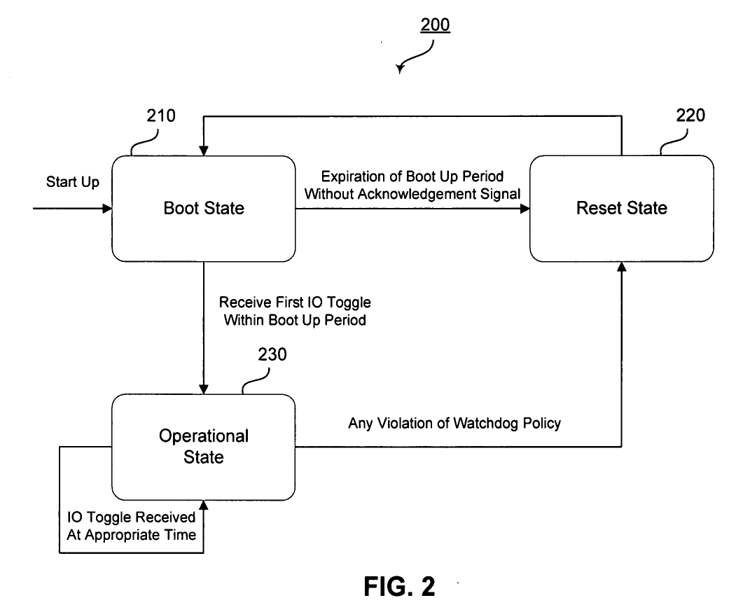

FIG. 2 illustrates an overall state diagram 200 of the watchdog system 100 according to at least one embodiment of the invention. The state diagram 200 comprises three states: a boot state 210, a reset state 220, and an operational state 230. In operation, the watchdog system 100 is in the boot state 210 on power up or start up. The boot state 210 is associated with the boot up period provided by the delay component 130. If the processor fails to send an acknowledgement signal before the expiration of the boot up period, the watchdog system 100 moves to the reset state 220 wherein the save & reset logic 160 resets the processor. However, if an acknowledgement signal is received during the boot up period, the watchdog system 100 moves to the operational state 230 immediately. The operational state 230 is the state in which the system 100 monitors the processor's activity after boot up. As will be further described, any violation of a watchdog policy specifying the proper timing of the acknowledgement signals transitions the watchdog system 100 from the operational state 230 to the reset state 220. For example, if the first acknowledgement signal is received during the forbidden period, or a later acknowledgment signal is received during an acknowledgement period, the watchdog system 100 enters the reset state 220. Moreover, if all the acknowledgement signals are not received before the expiration of the cycle period, the watchdog system 100 enters the reset state 220.

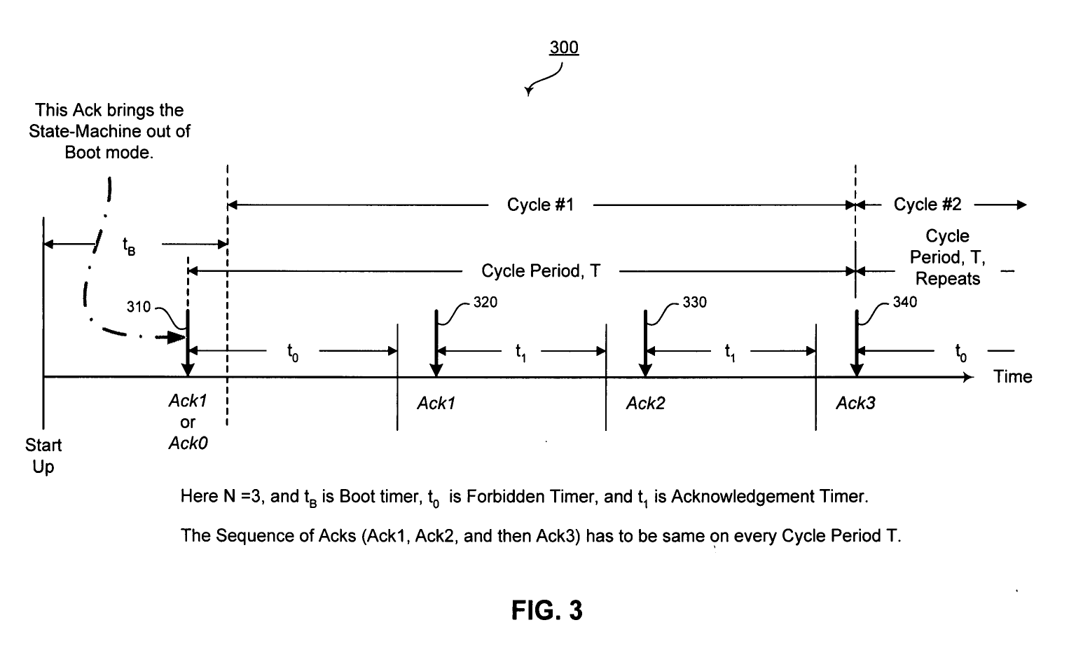

FIG. 3 illustrates a watchdog policy 300 according to at least one embodiment of the invention. This policy is exemplary only and to simplify discussion, applicable to the system 100, wherein N=3, i.e., three different IO lines 115A-C are employed. The watchdog policy 300 employs the four time periods introduced above: the boot up period (denoted as “t_{B}”); the forbidden period (denoted as “t₀”); the acknowledgement period (denoted as “t₁”); and the cycle period (denoted as “T”). Upon start up of the processor, the boot up period, t_{B}, is started. Before the expiration of this period, a first acknowledgement signal 310 (“Ack1”), i.e., the toggling of the first IO 115A, is expected. Failure to receive the first acknowledgement signal during the boot up period results in a reset of the processor. Upon receiving an acknowledgement signal 310 during the boot up period, normal operational state cycle 230 begins.

The boot up time period, t_{B}, provides a period of time just long enough to allow the processor or the board upon which the processor is connected to properly initialize (boot). If the processor takes longer than the boot up time period provided to boot up or if it doesn't boot up at all, the first acknowledgement signal 310 will not be received in time and thus, the watchdog system 100 will reset the processor.

The first cycle of the operational state 230 starts with the forbidden period, to, and the cycle period, T, upon receiving the first acknowledgement signal 310. At the expiration of the forbidden period, another first acknowledgement signal 320 (“Ack1”), i.e., the toggling of the first IO line 115A, is expected. In a related embodiment of the invention, an independent IO line other than one of IO lines 115A-C could be implemented just for the boot process (to receive acknowledgement signal 310 referred to as “Ack0,” which will not be used for any other modules). A separate IO line for the boot alone would be possible if the use of resources, i.e., IO lines, was not constrained to prevent such. In this case, one would need N+1 IO lines in system 100. In another related embodiment of the invention, the acknowledgement signal 310 could be received via any one of the IO lines 115A-C.

After receiving Ack1, an acknowledgement period, t₁, is started. At the expiration of this acknowledgement period, a second acknowledgement signal 330 (“Ack2”), i.e., the toggle of the second IO 115B, is expected. Once the second acknowledgement signal 330 is received, the acknowledgement period is restarted. At the expiration of this second acknowledgement period, a third acknowledgement signal 340 (“Ack3”), i.e., the toggle of the last IO 115C, is expected. Reception of the N^{th}, e.g., third, acknowledgement signal 340 ends the cycle and a new cycle of the operational state 230 is started, i.e., the forbidden period and cycle period are restarted and the above process not including the boot up period repeats. The sequence of acknowledgement signals, i.e., Ack1, Ack2, and then Ack3, has to be the same for every cycle.

If an acknowledgement signal is received during the forbidden period or any of the acknowledgement periods, then the processor is reset by the watchdog system 100. Moreover, the N^{th} acknowledgement signal (Ack3 in FIG. 3) must be received before the expiration of the cycle period, T. Failure to receive such also causes the system 100 to reset the processor. The monitor 180 also checks the sequence of the received acknowledgement signals 310-340. For example, if Ack3 is received before Ack2, but all parameters of the watchdog policy are otherwise satisfied, the monitor 180 triggers a reset of the processor. The cycle period, T; boot up time period, t_{B}; forbidden time period, t₀; and acknowledgement period, t₁, can be individually set to any desired time limit. Moreover, the time lapse between the expiration of the forbidden time period, t₀, and Ack1, and between the expiration of any acknowledgement period, t₁, and the next corresponding and subsequent acknowledgement signal (e.g., Ack2 or Ack3) can vary as long as the Nₜₕ acknowledgement signal, i.e., Ack3, is received before the expiration of the cycle period, T.

As stated, if the N^{th} acknowledgement signal (i.e., Ack3) is properly received before the end of the cycle period, T, the operational state 230 is continued by repeating another cycle. In such a case, the forbidden period and the cycle period is restarted upon receiving the N^{th} acknowledgement signal. Like the cycle before, the first acknowledgement signal Ack1 is expected after the forbidden period expires. After receiving Ack1, the acknowledgement period, t₁, is started and the second acknowledgement signal Ack2 is expected and so on until the cycle properly ends. This process continuously repeats unless a violation of the watchdog policy 300 occurs or the system 100 or processor is shut down.

In at least one embodiment of the invention, the forbidden and acknowledgement periods can be set to the same value and be provided by the same counter/timer.

The present invention provides a scheme to check the processor periodically to ensure proper operation of the processor. In sum, this is accomplished by receiving acknowledgements signals, e.g., IO line toggles, at relatively constant intervals from the processor. The watchdog system 100 is in an operational state 230 that is supported by three timers or counters that provide the cycle period, T, the forbidden time period, t₀, and the acknowledgement period, t₁. This scheme requires the processor “not to acknowledge” during the forbidden and acknowledgment periods. At the expiration of the forbidden period, the acknowledgement period is implemented N−1 times for every cycle. In one full cycle period, T, N different IO lines should have been toggled. Any improper order of or loss of periodicity in the acknowledgement signals results in the transition of the watchdog system 100 to the reset state 220, thereby resetting the processor.

Because the present watchdog scheme uses N different IO lines, an indefinite loop generating a repeated acknowledgement signal can not escape reset as the identity and sequence of the acknowledgement signals received is just as important as the timing of those acknowledgement signals.

The present invention is suitable for processors without IO pins. In an exemplary embodiment, writing “0x55” into a first register location is equivalent to a first IO toggle and writing “0xAA” into a second register location is equivalent to a second IO toggle. Writing any other pattern in these locations will not be considered as a proper IO toggle and thus, the processor is reset.

The present invention is well suited for monitoring software with synchronous tasks or asynchronous tasks. For software with synchronous tasks, the order of execution of each task is predefined, and each task acknowledges the watchdog system by toggling an IO line. Thus, the watchdog system monitors the order of execution as well as the periodicity. For software with asynchronous tasks, the watchdog system can interface with a central watchdog task manager that toggles the IO lines as required by the watchdog. The central watchdog task manager in turn monitors the activity of each individual task by a periodic query-response mechanism. The watchdog task manager is a software component that interacts with all the tasks present in the system by sending a query or request periodically. The summoned task would respond by sending a response. If the watchdog manager task receives the response, it would send an acknowledgement signal to the watchdog system 100, else the watchdog system 100 would reset the processor. If desired, a more sophisticated watchdog task manager can be implemented to kill the task, which didn't respond, thereby allowing the killed task to be reloaded separately if all the other remaining tasks are running properly.

The present invention is also suited for multi-processor architectures. In such a scenario, one or more IO lines from each processor is connected to the control logic 120. In a multi-processor system, a system control processor could broadcast a query to the rest of the processors and the processors should send acknowledgement signals directly to the watchdog system 100.

Although the invention has been particularly shown and described with reference to several preferred embodiments thereof, it will be understood by those skilled in the art that various changes in form and details may be made therein without departing from the spirit and scope of the invention as defined in the appended claims.

1. A watchdog system for monitoring functionality of a processor, the system comprising:
control logic having N number of acknowledgement signal inputs;
a first timer, wherein said first timer is started upon boot up of said watchdog system;
a second timer;
a third timer, wherein said second and third timers are started upon receiving a first acknowledgement signal at one of said N number of acknowledgement signal inputs; and
a reset signal generator.

2. The watchdog system of claim 1, wherein said reset signal generator generates a reset signal upon any one of the following conditions being met:
(i) not receiving an acknowledgement signal at one of said N number of acknowledgement signal inputs before an expiration of said first timer, (ii) receiving an acknowledgement signal at one of said N number of acknowledgement signal inputs before an expiration of said second timer; and (iii) not receiving an acknowledgement signal at all of said N number of acknowledgement signal inputs before an expiration of said third timer.

3. The watchdog system of claim 1, further comprising an interface coupled to said control logic via said N number of acknowledgement signal inputs, wherein said interface couples said processor to said watchdog system.

4. The watchdog system of claim 3, wherein said reset signal resets said processor coupled to said processor interface.

5. The watchdog system of claim 4, further includes logic to save information pertaining to a state of said processor immediately prior to reset.

6. The watchdog system of claim 1, wherein a duration of each of said timers can be set to unique values.

7. The watchdog system of claim 1, wherein said N number of acknowledgement signal inputs are input/output lines.

8. The watchdog system of claim 1, wherein said N number of acknowledgement signal inputs are registers.

9. A method of monitoring functionality of a processor comprising the steps of:
starting a first timer;
starting a second timer,
receiving at least one acknowledgement signal from a processor or software module;
upon the reception of every one of at least one acknowledgement signal, restarting said first timer; and
resetting said processor if any one of the following conditions are met:
(i) receiving any one of said at least one acknowledgement signal prior to an expiration of said first timer and (ii) not receiving all of said at least one acknowledgement signal prior to an expiration of said second timer.

10. The method of claim 9, wherein said first and second timers are started simultaneously.

11. The method of claim 10 further comprising the step of receiving a signal indicating that said processor is properly initialized,
wherein said first and second timers are started upon receiving said initialization signal.

12. The method of claim 9, wherein said step of resetting said processor further comprises the step of:
storing state information pertaining to said processor.

13. The method of claim 9, further comprising the step of
starting a boot up timer, and
resetting said processor if an initialization signal is not received from said processor prior to an expiration of said boot up timer, wherein said initialization signal indicates that said processor is properly initialized.

14. The method of claim 13, wherein said first and second timers are simultaneously started upon receiving said initialization signal.

15. A method for resetting a processor coupled to a watchdog comprises the steps of:
monitoring a processor using a watchdog coupled to said processor,
resetting said processor using said watchdog,
storing state information of said processor immediately prior to resetting said processor, wherein said state information indicates a state the processor was in prior to reset.

16. The method of claim 15, wherein said step of storing comprises the step of asserting a nonmaskable interrupt (NMI).

17. A watchdog system for monitoring functionality of a processor, the system comprising:
control logic having N number of acknowledgement signal inputs;
a boot up timer, wherein said boot up timer is started at the start of a boot up of a processor;
a forbidden timer, wherein the said forbidden timer is started upon start of every operational cycle after completion of a successful boot up of said processor,
an acknowledgement timer, wherein said acknowledgement timer is started upon receiving an acknowledgement signal at one of said N number of acknowledgement signal inputs;
a cycle period timer, wherein said cycle period timer is started upon start of every operational cycle after completion of a successful boot up of said processor; and
a reset signal generator.

18. The watchdog system of claim 17, wherein said reset signal generator generates a reset signal to send to said processor upon any one of the following conditions being met:
(i) not receiving an acknowledgement signal at a first one of said N number of acknowledgement signal inputs before an expiration of said boot up timer, (ii) receiving an acknowledgement signal at any one of said N number of acknowledgement signal inputs before an expiration of said acknowledgement timer; (iii) receiving an acknowledgement signal at any one of said N number of acknowledgement signal inputs before an expiration of said forbidden timer and (iv) not receiving an acknowledgement signal at all of said N number of acknowledgement signal inputs before an expiration of said cycle period timer.

19. The watchdog system of claim 17, further comprising an interface coupled to said control logic via said N number of acknowledgement signal inputs, wherein said interface couples said processor to said watchdog system.

20. The watchdog system of claim 19, wherein said reset signal resets said processor coupled to said processor interface.

21. The watchdog system of claim 20, further includes logic to save information pertaining to a state of said processor immediately prior to reset.

22. The watchdog system of claim 17, wherein a duration of each of said timers can be set to unique values.

23. The watchdog system of claim 17, wherein said N number of acknowledgement signal inputs are input/output lines.

24. The watchdog system of claim 17, wherein said N number of acknowledgement signal inputs are registers.

25. A method of monitoring the functionality of a processor comprising the steps of:
starting a boot up timer,
starting a forbidden timer;
starting a cycle period timer;
receiving at least one acknowledgement signal;
upon the reception of one of at least one acknowledgement signal, starting an acknowledgement timer; and
resetting said processor if any one of the following conditions are met:
(i) not receiving any one of said at least one acknowledgement signal prior to an expiration of said boot up timer; (ii) receiving any one of said at least one acknowledgement signal prior to an expiration of said acknowledgement timer; (iii) receiving any one of said at least one acknowledgement signal prior to an expiration of said forbidden timer, and (iv) not receiving all of said at least one acknowledgement signal prior to an expiration of said cycle period timer.
